(19) United States
(12) Patent Application Publication
(10) Pub. No.: US 2025/0020280 A1
(43) Pub. Date: Jan. 16, 2025

(54) FACILITY AND METHOD FOR DISTRIBUTING LIQUEFIED HYDROGEN

(71) Applicant: L'Air Liquide, Societe Anonyme pour l'Etude et l’Exploitation des Procedes Georges Claude, Paris (FR)

(72) Inventors: Laurent ALLIDIERES, Paris (FR); Claire GIRARD, Les Loges-En-Josas (FR); Gregoire RIGOUT, Les Loges-En-Josas (FR); Bertille GUENEGO, Champigny-Sur-Marne (FR)

(73) Assignee: L'Air Liquide, Societe Anonyme pour l'Etude et l’Exploitation des Procedes Georges Claude, Paris (FR)

(21) Appl. No.: 18/580,979

(22) PCT Filed: Jun. 14, 2022
(86) PCT No.: PCT/EP2022/066130

§ 371 Date: Sep. 26, 2024

(30) Foreign Application Priority Data
Jul. 19, 2021 (FR) FR 2107747

(51) Int. Cl. F17C 5/00; F17C 5/02; F17C 5/06

(52) U.S. Cl. CPC F17C 5/007; F17C 5/02; F17C 5/06; F17C 2205/0338; F17C 2221/012; F17C 2223/0153; F17C 2227/0157; F17C 2227/0337; F17C 2250/0626; F17C 2250/0694; F17C 2265/065; F17C 2270/0171

(57) ABSTRACT

A facility for distributing liquefied hydrogen comprising a source of gaseous hydrogen, a liquefier, at least one means for storing liquid hydrogen, the liquefier comprising an outlet connected to an inlet of the storage means via a liquid circuit the facility comprising a liquid filling circuit provided with a first end connected to the storage means and a second end intended to be removably connected to a first end of a mobile liquid tank 6) to be filled, the facility further comprising a gas recovery circuit provided with a first end intended to be removably connected to a second end of the tank and a second end connected to a receiving member of the facility, the gas recovery circuit comprising a pressure and/or flow-rate regulating member, such as a valve for lowering the pressure in the mobile liquid tank to a determined filling pressure, the facility comprising an electronic control member comprising a microprocessor configured to receive at least one filling request signal from a mobile liquid tank, the pressure and/or flow-rate regulating member being adjustable and the electronic control member being configured to actuate the latter to regulate the pressure level in a mobile liquid tank to a determined filling pressure based on a received filling request signal.

### CROSS REFERENCE TO RELATED APPLICATIONS

This application is a § 371 of International PCT Application PCT/EP2022/066130, filed Jun. 14, 2022, which claims the benefit of FR2107747, filed Jul. 19, 2021, both of which are herein incorporated by reference in their entireties.

### FIELD OF THE INVENTION

The invention relates to a facility and a method for distributing liquefied hydrogen.

### BACKGROUND OF THE INVENTION

A hydrogen liquefier is generally configured to operate at nominal load and produce liquid hydrogen at a given temperature. The liquid hydrogen produced is stored in one or more storage reservoirs from which mobile tanks (semi-trailers) are filled.

The liquefier storage reservoir and the associated loading procedure for filling trailers from the storage reservoir are also designed to operate under fixed operating conditions. Indeed, all these parameters are generally optimized during the design phase. Then, during the operation phase, these parameters remain the same, regardless of the trailer to be filled and the customers receiving delivery.

However, usually several customers (reception points) are to receive a delivery of liquid hydrogen from this facility, with different logistics and different expectations (hydrogen dense or cold to varying degrees).

To this end, the nominal liquefied hydrogen production point is set at the level necessary to satisfy the most demanding customer. As a result, the facility wastes part of its energy producing “excessively high quality” hydrogen for certain users.

An aim of the present invention is to overcome all or some of the prior art drawbacks outlined above.

### SUMMARY OF THE INVENTION

In certain embodiments, the invention relates more particularly to a facility for distributing liquefied hydrogen comprising a source of gaseous hydrogen, a liquefier, at least one liquid hydrogen storage reservoir, the liquefier comprising an inlet connected to the source and an outlet connected to an inlet of the storage reservoir via a liquid circuit for storing therein liquefied hydrogen produced by the liquefier, the facility comprising a liquid filling circuit provided with a first end connected to the storage reservoir and a second end intended to be removably connected to a first end of a mobile liquid tank to be filled such as a semi-trailer, the facility further comprising a gas recovery circuit provided with a first end intended to be removably connected to a second end of said tank and a second end connected to a receiving member of the facility, in particular an inlet of the liquefier, the gas recovery circuit comprising a pressure and/or flow rate regulation member, such as a valve making it possible to lower the pressure in the mobile liquid tank to a predetermined filling pressure, the facility comprising an electronic control unit comprising a microprocessor configured to control all or part of the facility, the electronic control unit being configured to receive at least one signal requesting filling of a mobile liquid tank.

In an effort to overcome the deficiencies of the prior art discussed, supra, the facility according to the invention, which moreover conforms to the generic definition given in the preamble above, the pressure and/or flow rate regulation member is adjustable and in that the electronic control unit is configured to control the latter to regulate the pressure level in a mobile liquid tank to a predetermined filling pressure as a function of a filling request signal received.

In certain embodiments, the invention makes it possible to fill tanks at the optimum pressure meeting customer expectations for delivery, without excessive production of vaporization gas during filling.

By contrast, according to known solutions, too low a pressure was imposed in the mobile tank for certain deliveries. This represents energy expended that is not utilized and is costly for the facility. It in fact generates more flash gas than for a higher pressure. This flash gas generated when filling a tank at relatively low pressure is not transported. This gas is either vented or reliquefied in the liquefier. However, if the tank leaves with too low a pressure, additional liquid will be evaporated to pressurize it at the stations (increasing the boil-off gas).

In addition, embodiments of the invention may include one or more of the following features:
the gas recovery circuit comprises a compression member arranged between the pressure and/or flow rate regulation member and the second end connected to the liquefier, the compression member being configured to compress the flow of gas coming from the first end to a predetermined pressure with a view to reinjecting same into the liquefier circuit,
the predetermined filling pressure is selected between a predetermined minimum pressure and a predetermined maximum pressure,
the predetermined minimum pressure (Pmini) is equal to 1.05 bar,
the compression member is configured to operate with a minimum intake pressure at the inlet of said compression member, the predetermined minimum pressure (Pmini) being equal to the minimum intake pressure of the compression member increased by a predetermined value corresponding at least to the pressure loss in the gas recovery circuit between the first end and the inlet of said compression member,
the predetermined maximum pressure is equal to the value of the pressure within the storage reservoir, reduced where appropriate by the value of the pressure loss between the storage reservoir and the second end of the liquid filling circuit, the electronic control unit is configured to receive at least one signal requesting filling of a mobile liquid tank comprising at least one of the following filling parameters: maximum pressure level allowed in the tank, fluid pressure level required at the reception point(s) to which the tank must deliver liquefied hydrogen after filling, quantity of liquefied hydrogen to be filled in the tank, distance that the tank must travel after filling to in turn deliver liquefied hydrogen to the reception point(s), number of reception points to which the tank must deliver liquefied hydrogen after filling, the temperature in the storage reservoir, the volume of the tank; the electronic control unit being configured to calculate the predetermined filling pressure level as a function of said parameter(s),
the liquefier is of the type with controlled variable cooling power, that is to say making it possible to vary the temperature of the liquid hydrogen produced and in particular to produce liquid hydrogen that is sub-cooled relative to its saturated state, the electronic control unit is configured to control the temperature level of the liquid hydrogen produced in the storage reservoir as a function of the request signal received,
the liquid filling circuit comprises two withdrawal pipes connected at two different heights of the storage reservoir to draw off hydrogen therefrom under different respective thermodynamic conditions,
the facility comprises two separate storage reservoirs filled at different liquid hydrogen temperatures, the first end of the liquid filling circuit being connected to the storage reservoirs, the liquid filling circuit comprising a set of valve(s) configured to allow filling of a tank with a mixture of liquid coming from the storage reservoirs to obtain a predetermined liquid temperature.

The invention also relates to a method for distributing liquefied hydrogen using a facility according to any of the features above or below, comprising a step of generating a signal requesting filling of a mobile liquid tank, a step of calculating a predetermined filling pressure level as a function of said signal and a step of filling the tank with liquid hydrogen at the predetermined filling pressure level.

According to other possible features:
the predetermined filling pressure level is regulated during the filling step by controlling the opening of the pressure and/or flow rate regulation member,
the control of the opening of the pressure and/or flow rate regulation member is carried out upon a tank degassing operation during and/or before and/or following a transfer of liquid hydrogen into the tank,
the step of generating a filling request signal is carried out manually and/or by telemetry, said signal being transmitted to the facility,
the method comprises, prior to a transfer of liquid hydrogen into the tank from the storage reservoir, a step of calculating a predetermined temperature value of liquefied hydrogen produced in the storage reservoir as a function of said signal and a step of filling the storage reservoir with liquefied hydrogen at said predetermined temperature,
the method comprises, prior to a transfer of liquid hydrogen into the tank from the storage reservoir, a step of filling two separate storage reservoirs with liquefied hydrogen at different temperatures and a step of calculating a predetermined liquefied hydrogen temperature value as a function of said signal and a step of filling a tank at said predetermined temperature via a mixture of liquefied hydrogen coming from said storage reservoirs.

The invention may also relate to any alternative device or method comprising any combination of the features above or below within the scope of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Other particular features and advantages will become apparent from reading the following description, provided with reference to the figures in which:

FIG. 1 is a schematic partial view illustrating an example of the structure and operation of an embodiment of a liquefied hydrogen distribution facility according to the invention,

FIG. 2 shows a detail of such a facility in a first alternative embodiment with control of the temperature of the liquid hydrogen produced and stored,

FIG. 3 shows a detail of such a facility in a second alternative embodiment with withdrawal of liquid at different levels of the storage reservoir,

FIG. 4 shows a detail of such a facility in a third alternative embodiment with several storage reservoirs.

### DETAILED DESCRIPTION OF THE INVENTION

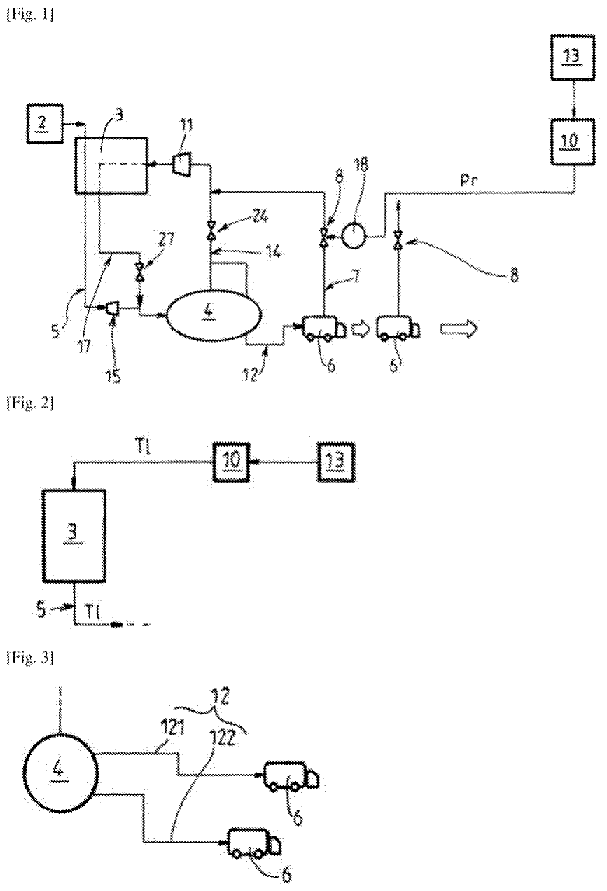

The liquefied hydrogen distribution facility 1 depicted in FIG. 1 comprises a source 2 of gaseous hydrogen, a liquefier 3 and at least one liquid hydrogen storage reservoir 4.

The source 2 may comprise a hydrogen supply network and/or hydrogen production equipment such as an electrolyzer for example.

The liquefier 3 is for example a liquefier using a cycle gas (comprising for example hydrogen and/or helium) which undergoes a thermodynamic cycle producing at one end of the cycle cold which is placed in heat exchange with a flow of hydrogen to be cooled with a view to its liquefaction.

The liquefier 3 therefore comprises an inlet connected to the source 2 and an outlet connected to an inlet of the storage reservoir 4 via a liquid circuit 5 so as to store therein liquefied hydrogen produced by the liquefier 3.

The facility 1 further comprises a liquid filling circuit 12 provided with a first end connected to the bottom of the storage reservoir 4 and a second end intended to be removably connected to a first end of a mobile liquid tank 6 to be filled, such as a semi-trailer, to transfer liquid hydrogen thereto.

The facility 1 further comprises a gas recovery circuit 7 (for recovery of vaporization gas contained in the tanks 6 to be filled) provided with a first end intended to be removably connected to a second end of said storage reservoir 4 (typically the upper end) and a second end connected to a receiving member of the facility 1.

The gas recovery circuit 7 comprises a pressure and/or flow rate regulation member 8, such as a valve making it possible to lower the pressure in the mobile liquid tank 6 to a predetermined filling pressure Pr. This pressure and/or flow rate regulation member 8 is adjustable, that is to say it makes it possible to set the residual pressure level in the tank 6 (controlled degassing).

For example, the second end is connected to an inlet of the liquefier 3 to recover the gaseous hydrogen in the liquefier circuit to be liquefied.

For this purpose, the gas recovery circuit 7 preferably comprises a compression member 11 such as a compressor for example (or compression unit) placed between the pressure and/or flow rate regulation member 8. Thus, the compressor 11 may be configured to compress the flow of gas coming from the first end to a predetermined pressure with a view to its reinjection, for example into the circuit of hydrogen to be liquefied of the liquefier 3.

As shown, downstream of the compressor 11, the flow of recovered vaporization gas may be allowed to circulate for example in a passage of a set of exchanger(s) for cooling the liquefier 3 which is separate from the main circuit 5 for liquefaction of the hydrogen supplied by the source. In other words, the vaporization gas flow may be liquefied separately from the main hydrogen flow. This recovered and cooled vaporization gas may be transported on leaving the liquefier 3 in a pipe 17 (possibly provided with a valve 27) which may be connected to the liquid circuit 5 (after leaving the liquefier, for example in or just before the inlet into the storage reservoir 4). As shown, this cooled (and where appropriate at least partially liquefied) gas may be mixed with the liquid hydrogen of the liquid circuit 5, for example downstream of a final expansion member 15 (for example a turbine and/or a valve) of the liquid circuit 5.

As also shown, an upper end of the storage reservoir 4 may be connected to the inlet of the compressor 11 via a pipe 14 preferably provided with a valve 24. This makes it possible, where appropriate, to also recover the vaporization gas from the storage reservoir 4 in the compressor with a view to its recycling and liquefaction.

The facility 1 may comprise a set of valve(s) and appropriate members not shown for the sake of simplification.

The facility 1 comprises an electronic control unit 10 comprising a microprocessor (for example a computer or a programmable electronic calculator) configured to control all or part of the facility 1. This control unit 10 may be housed in the facility 1 and/or remote and composed of one or more electronic units.

This electronic control unit 10 is configured to receive at least one signal 13 requesting filling of a mobile liquid tank 6 to be filled.

The electronic control unit 10 is configured to control the pressure and/or flow rate regulation member 8 to regulate the pressure level in a mobile liquid tank 6 filled at a predetermined filling pressure Pr as a function of the request signal 13 received. This makes it possible to adjust the pressure of the tank 6 which will be filled at the optimal pressure taking into account the needs and constraints of the mobile tank 6, in particular with regard to its subsequent deliveries. The filling pressure Pr may thus be calculated to correspond to the optimal thermodynamic state in order not to exceed the limit specified by the customers to whom liquefied gas will be delivered by the tank 6.

This predetermined filling pressure Pr is selected between a predetermined minimum pressure Pmini and a predetermined maximum pressure Pmax.

This predetermined minimum pressure Pmini is for example equal to a predetermined fixed value, for example 1.05 bar, particularly in the case where some of the vaporization gas (BOG) may be vented from the tank 6 (additional depressurization before departure of the filled tank 6).

In the case where there is complete recovery of this vaporization gas from the tank 6 at the facility 1, this minimum pressure Pmini may be equal to the minimum intake pressure of the compression unit 11 plus the pressure loss to be overcome by the return of this vaporization gas between the tank 6 and the inlet of the compression unit 11.

The predetermined maximum pressure Pmax is equal to the value of the pressure within the storage reservoir 4 reduced where appropriate by the value of the pressure loss between the storage reservoir 4 and the second end of the liquid filling circuit 12. In other words, this predetermined maximum pressure Pmax may be specified by the pressure of the storage reservoir 4 of the facility 1 minus the pressure loss between the storage reservoir 4 and the tank 6 (trailer) if a transfer pump is not available to transfer the liquid into the liquid filling circuit.

This predetermined maximum pressure Pmax may be specified by the pressure of the storage reservoir 4 of the facility if, on the contrary, a transfer pump is available in the liquid filling circuit.

The electronic control unit 10 is thus configured to receive at least one signal 13 requesting filling of a mobile liquid tank 6, which specifies at least one filling parameter.

This signal 13 may include for example at least one of the following filling parameters: maximum pressure level allowed in the tank 6, fluid pressure level required at the reception point(s) to which the tank 6 must deliver liquefied hydrogen after filling, quantity of liquefied hydrogen to be filled in the tank 6, distance that the tank 6 must travel after filling to in turn deliver liquefied hydrogen to the reception point(s), number of reception points to which the tank 6 must deliver liquefied hydrogen after filling, volume of the tank 6.

The electronic control unit 10 is configured to calculate the optimal predetermined filling pressure level Pr as a function of these parameter(s),

In other words, the facility 1 optimizes and adapts the filling pressure for the mobile tank 6 as a function of the key logistical parameter(s) pertaining to the next delivery, for example the distances and the expectations of the customers to whom liquid hydrogen is to be delivered.

These optimal thermodynamic filling conditions may be determined automatically by a programmed tool.

For example, a customer (delivery point) may set a filling temperature limit, in order to only purchase cold hydrogen at a specific temperature. As the saturated pressure (and hence the temperature) inside the mobile tank 6 increases with distance traveled (linearly for a specified tank 6 liquid level). The customer may specify the maximum acceptable delivery temperature of their receiving station.

The facility 1 may also receive information on the number of stations taking delivery (the rate of increase in pressure increases with the number of stations taking delivery and the decrease in the liquid level in the mobile delivery tank 6).

The electronic control unit 10 is configured to calculate the optimal thermodynamic filling point (pressure between Pmin and Pmax) in order not to exceed the limit specified by the customer(s).

This information or these parameters may be transmitted manually and/or via a telemetry type transmission system. For example, logistics and tank (trailer) data are transmitted to the electronic control unit 10 which then calculates the optimal filling pressure Pr.

Alternatively, the optimal filling pressure for the tank 6 is transmitted by the tank 6, for example at the loading dock, for example via the operator in charge of filling the tank 6.

Several types of filling are possible to reach this calculated optimal thermodynamic filling point.

For example, the electronic control unit 10 may calculate the ideal filling pressure for the tank 6 taking into account the next planned delivery of liquid. The optimal pressure value is preferably the maximum value that will guarantee compliance with customer requirements and road legislation. Selecting the maximum pressure possible instead of a lower default value (often 1.15 bara) makes it possible to limit the quantity of evaporation gas that will be produced due to flash when filling the tank 6. This also facilitates the recycling of evaporation gas (less depressurization required).

The filling pressure for the tank 6 may thus be regulated by opening the pressure and/or flow rate regulation member 8 (degree of opening and/or length of time open) to lower the pressure in the tank 6 to be filled connected to the facility 1.

In the case where the facility 1 includes several filling lines allowing simultaneous filling of several mobile tanks 6, each of the members 8 (valves for example) is preferably individually controllable.

For example, this or these valves 8 may be controlled and/or automatic with a variable setpoint. Thus, the pressure setpoint of this member 8 may be controlled for example via a “PIC” valve control 18 (pressure independent automatic balancing and control valve). Naturally, any other type of valve and control that are appropriate may be considered.

This step of controlled depressurization of the tank 6 is preferably carried out before the step of filling with liquid and is carried out up to the ideal pressure calculated as explained above. This avoids venting to the open air and facilitates the recycling of vaporization gases within the facility 1. Moreover, the depressurization step is shorter compared to the prior art.

Depending on the planned frequency of filling of the tanks 6, the logistics and the number of loading docks, the facility 1 may include one or more gas recovery circuits 7 (thermally insulated return lines) leading to the liquefier 3.

For example, for liquefiers 3 of relatively small size or capacity, a single tank 6 could be depressurized/filled at a time and a single gas return line 7 may be sufficient. On the other hand, separate gas return lines 7 may be envisaged if several tank 6 filling operations are possible (potentially at different optimal thermodynamic filling points).

The setpoint for filling the tank 6 will therefore influence the pressure setpoint of the associated return line 7. Several return lines may benefit from the same thermal insulation.

In the case where the expected delivery conditions are homogeneous for a relatively long period (for example several days and in particular more than 15 days), the facility 1 may be configured to modify the predetermined pressure in the storage reservoir 4 receiving liquid from the liquefier 3. This also makes it possible, if necessary, to adapt the facility 1 to the optimal pressure for filling the tank 6.

If a filling pump is available in the liquid filling circuit 12, this target pressure for the storage reservoir 4 is preferably equal to the filling pressure for the tank 6.

In the case where filling of the tank 6 is carried out without a pump, a sufficient pressure difference between the storage reservoir 4 and the tank 6 is maintained to overcome the pressure loss in the pipework of the filling circuit 12 and to maintain the desired liquid filling flow rate. This pressure difference may be between 100 mbar and 500 mbar, and more preferably between 200 mbar and 300 mbar (for example depending on the length and diameter of the pipework of the circuit 12).

Preferably, the evaporation management system must be flexible in order to exploit a higher boiling pressure.

Thus, although simple and inexpensive in structure, the invention makes it possible to optimize the entire chain from the liquefier 3 to the receiving station to which the mobile tank 6 delivers liquefied gas. The invention makes it possible to adapt the filling of the tanks 6 (trailers) to the optimal thermodynamic conditions, in order to meet the requirements of the end customer(s) to whom liquid is delivered, while minimizing the cost of the facility 1 (in particular without unnecessary liquefaction and cooling power).

The facility and the method allow filling of cryogenic liquid delivery tanks 6 for an optimal logistics chain (in particular minimization of vaporization gas during filling of the tank 6).

Additionally, as described above, the thermodynamic conditions (for example pressure and/or temperature) in the storage reservoir 4 may be regulated taking into account subsequent deliveries.

As shown schematically in FIG. 2, in the case of a liquefier 3 of the type capable of producing sub-cooled and flexible liquefied hydrogen, it is possible to additionally control the facility 1 by modifying the temperature Tl of the liquid produced as a function of the aforementioned parameter(s).

For example, in the case where the facility 1 comprises a single available storage reservoir 4, for a given filling pressure of the tank 6 (for example between 1.15 bara and 2 bara, and preferably between 1.15 and 1.5 bara), the temperature of the liquefied hydrogen will have an impact on the resulting pressure when the tank 6 is moved.

To be specific, a tank 6 filled with sub-cooled liquid hydrogen will reach equilibrium during its movement and the pressure will drop to saturation pressure. The optimal temperature of the liquid hydrogen entering the tank 6 may also be determined by the programmed electronic control unit 10. The temperature of the liquefied hydrogen produced (sub-cooled or otherwise) may be adjusted also taking into account the parameters of the filling request (next delivery or deliveries) and injected into the bottom of the storage reservoir 4. Specifically, the sub-cooled hydrogen will be stored at the bottom of the storage reservoir 4 by virtue of the stratification of the hydrogen within it.

Thus, for example, if customers require relatively high quality liquid hydrogen, the necessary quantity of sub-cooled hydrogen must be produced and injected into the bottom. On the other hand, for less demanding customers, the production of saturated liquid hydrogen may be sufficient to meet their requirements.

The rate of filling of the tank 6 is generally greater than the rate of filling of the storage reservoir 4. It is therefore preferable to anticipate filling of the storage reservoir 4, particularly in terms of temperature.

The bottom of the storage reservoir 4 is therefore preferably filled in advance of filling of the tanks 6 with sub-cooled liquid hydrogen. At the end of filling of the storage reservoir 4, the quantity of sub-cooled hydrogen produced and sent to the bottom of the storage reservoir 4 must correspond at least to the mass which will be filled in the tank 6. This mass could be optimized to also compensate for heat input from the circuit lines. On the basis of the rate of production of liquefied hydrogen (which may vary in temperature) and the expected mass in the tank 6 to be filled, the facility 1 (for example the unit 10) may be configured to determine for example the start time and duration of optimized sub-cooled hydrogen production.

As shown schematically in FIG. 3, for less variable sub-cooled hydrogen production, the liquid filling circuit 12 may comprise one or more other outlets of the storage reservoir 4 connected at different heights of the storage reservoir 4 via separate lines 121, 122. This may make it possible to draw off liquid from the storage reservoir 4 by taking advantage of the stratification of the hydrogen in the storage reservoir 4 (the sub-cooled hydrogen being in the lower part while the saturated hydrogen is in the upper part near the liquid/gas interface).

For example, if the optimal temperature required for filling is the saturation temperature, the intermediate storage reservoir outlet 121 may be used to draw off the liquid. The outlets may be connected via independent lines (and/or connected to a common pipe).

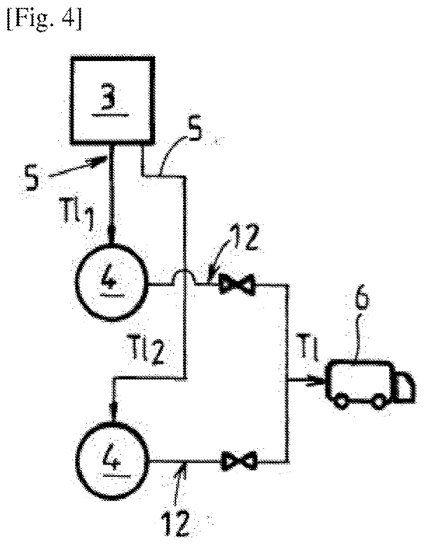

As shown schematically in FIG. 4, in the case where two (or more) storage reservoirs 4 are available in the facility 1, one of the storage reservoirs 4 may be filled with saturated hydrogen at the saturated temperature Tl1 while another storage reservoir 4 may be filled with sub-cooled liquid hydrogen (temperature Tl2).

The electronic control unit 10 may be configured (programmed) to determine the appropriate mixture of hydrogen from these storage reservoirs 4 to fill a tank 6 at the optimal target temperature. Regulation may be obtained by a set of control valve(s) controlling the flows drawn off from the storage reservoirs 4.

The storage reservoir 4 containing sub-cooled liquid may be used to compensate for flash and cooling losses, and could be used to fill a tank 6 with very cold hydrogen if necessary to achieve the required optimal thermodynamic filling point.

Thus, in this variant the facility 1 makes it possible to produce sub-cooled hydrogen at the optimized temperature and in the optimized quantity. This hydrogen may be stored at the bottom of a storage reservoir 4 to be used to fill a tank 6 in order to reach the optimal thermodynamic filling point.

The tank 6 may be filled by active pumping and/or simple passive connection with a pressure differential.

Thus, the facility 1 makes it possible, via the controlled opening of the pressure regulation member 8, to bring the tank to the filling pressure with a view to filling it with liquid. After filling, this pressure regulation member 8 (which may form part of the mobile tank 6) may be opened to further depressurize this tank 6 to a second lower pressure suitable for transport or delivery, for example.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-16. (canceled)

17. A facility for distributing liquefied hydrogen comprising:
a source of gaseous hydrogen;
at least one liquid hydrogen storage reservoir;
a liquefier, comprising an inlet connected to the source and an outlet connected to an inlet of the storage reservoir via a liquid circuit for storing therein liquefied hydrogen produced by the liquefier;
a liquid filling circuit provided with a first end connected to the storage reservoir and a second end configured to be removably connected to a first end of a mobile liquid tank to be filled such as a semi-trailer;
a gas recovery circuit provided with a first end configured to be removably connected to a second end of said mobile liquid tank and a second end connected to a receiving member of the facility, the gas recovery circuit comprising a pressure and/or flow rate regulation member that is configured to lower the pressure in the mobile liquid tank to a predetermined filling pressure; and
an electronic control unit comprising a microprocessor configured to control all or part of the facility, the electronic control unit being configured to receive at least one signal requesting filling of a mobile liquid tank,
wherein the pressure and/or flow rate regulation member is adjustable, and
wherein the electronic control unit is configured to control the pressure and/or flow rate regulation member to regulate the pressure level in a mobile liquid tank to a predetermined filling pressure as a function of a filling request signal received.

18. The facility as claimed in claim 17, wherein the gas recovery circuit comprises a compression member arranged between the pressure and/or flow rate regulation member and the second end connected to the liquefier, the compression member being configured to compress the flow of gas coming from the first end to a predetermined pressure with a view to reinjecting same into the liquefier circuit.

19. The facility as claimed in claim 17, wherein the predetermined filling pressure is selected between a predetermined minimum pressure and a predetermined maximum pressure.

20. The facility as claimed in claim 19, wherein the predetermined minimum pressure is equal to 1.05 bar.

21. The facility as claimed in claim 19, wherein in that the compression member is configured to operate with a minimum intake pressure at the inlet of said compression member, the predetermined minimum pressure being equal to the minimum intake pressure of the compression member increased by a predetermined value corresponding at least to the pressure loss in the gas recovery circuit between the first end and the inlet of said compression member.

22. The facility as claimed in claim 19, wherein in that the predetermined maximum pressure is equal to the value of the pressure within the storage reservoir reduced where appropriate by the value of the pressure loss between the storage reservoir and the second end of the liquid filling circuit.

23. The facility as claimed in claim 17, wherein the electronic control unit is configured to receive at least one signal requesting filling of a mobile liquid tank comprising at least one of the following filling parameters: maximum pressure level allowed in the tank, fluid pressure level required at the reception point(s) to which the tank must deliver liquefied hydrogen after filling, quantity of liquefied hydrogen to be filled in the tank, distance that the tank must travel after filling to in turn deliver liquefied hydrogen to the reception point(s), number of reception points to which the tank must deliver liquefied hydrogen after filling, the temperature in the storage reservoir, the volume of the tank: and in that the electronic control unit is configured to calculate the predetermined filling pressure level as a function of said parameter(s).

24. The facility as claimed in claim 17, wherein the liquefier is of the type with controlled variable cooling power, that is to say making it possible to vary the temperature of the liquid hydrogen produced and in particular to produce liquid hydrogen that is sub-cooled relative to its saturated state, and in that the electronic control unit is configured to control the temperature level of the liquid hydrogen produced in the storage reservoir as a function of the request signal received.

25. The facility as claimed in claim 24, wherein the liquid filling circuit comprises two withdrawal pipes connected at two different heights of the storage reservoir to draw off hydrogen therefrom under different respective thermodynamic conditions.

26. The facility as claimed in claim 24, further comprising separate storage reservoirs filled at different liquid hydrogen temperatures, the first end of the liquid filling circuit being connected to the storage reservoirs, the liquid filling circuit comprising a set of valve(s) configured to allow filling of a tank with a mixture of liquid coming from the storage reservoirs to obtain a predetermined liquid temperature.

27. A method for distributing liquefied hydrogen using a facility as claimed in claim 17, the method comprising the steps of:
generating a signal requesting filling of a mobile liquid tank;
calculating a predetermined filling pressure level as a function of said signal; and
filling the tank with liquid hydrogen at the predetermined filling pressure level.

28. The method as claimed in claim 27, wherein the predetermined filling pressure level is regulated during the filling step by controlling the opening of the pressure and/or flow rate regulation member.

29. The method as claimed in claim 28, wherein the control of the opening of the pressure and/or flow rate regulation member is carried out upon a tank degassing operation during and/or before and/or following a transfer of liquid hydrogen into the tank.

30. The method as claimed in claim 27, wherein the step of generating a filling request signal is carried out manually and/or by telemetry, said signal being transmitted to the facility.

31. The method as claimed in claim 27, further comprising, prior to a transfer of liquid hydrogen into the tank from the storage reservoir, a step of calculating a predetermined temperature value of liquefied hydrogen produced in the storage reservoir as a function of said signal and a step of filling the storage reservoir with liquefied hydrogen at said predetermined temperature.

32. The method as claimed in claim 27, further comprising, prior to a transfer of liquid hydrogen into the tank from the storage reservoir, a step of filling two separate storage reservoirs with liquefied hydrogen at different temperatures and a step of calculating a predetermined liquefied hydrogen temperature value as a function of said signal and a step of filling a tank at said predetermined temperature via a mixture of liquefied hydrogen coming from said storage reservoirs.
